(19) United States
(12) Patent Application Publication
(10) Pub. No.: US 2019/0241133 A1
(43) Pub. Date: Aug. 8, 2019

(54) ACOUSTIC AND THERMAL SHIELD FOR A MOTOR VEHICLE

(71) Applicant: TREVES PRODUCTS, SERVICES & INNOVATION, Paris (FR)

(72) Inventors: Stéphane RIBES, Romain (FR); Christophe CAPRON, Epoye (FR)

(21) Appl. No.: 16/317,302

(22) PCT Filed: Jul. 10, 2017
(86) PCT No.: PCT/FR2017/051889

§ 371 Date: Jan. 11, 2019

(30) Foreign Application Priority Data
Jul. 12, 2016 (FR) 1656698

(51) Int. Cl. B60R 13/08

(52) U.S. Cl. CPC B60R 13/0838; B32B 29/007; B60R 13/0815

(57) ABSTRACT

The invention relates to a shield comprising: a thermo-compressed porous three-dimensional shell based on glass fibers, the fibers being joined together by a binding agent. The shield includes a foam-based inner spring layer, and additionally has the following features: the foam layer is produced by reaction injection molding (RIM), the layer overmolding the shell. The shell has a porosity arranged in order to enable the foam to penetrate a fraction of the thickness of the shell, so as to create a leaktight skin the binding agent is based on polypropylene. The shell comprises between 45 and 55% by weight of glass fibers.

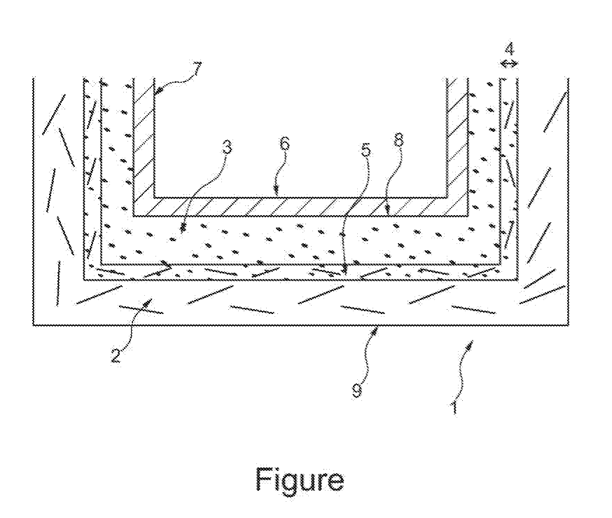

### CROSS-REFERENCE TO RELATED APPLICATION

This application claims the benefit of International application number PCT/FR2017/051889, filed Jul. 10, 2017 and French application number 1656698, filed Jul. 12, 2016 the entire contents of which are incorporated herein by reference.

### TECHNICAL FIELD

The invention relates to an acoustic and thermal shield for a motor vehicle, a mounting of such a shield and a method for producing such a shield.

### BACKGROUND

It is known to produce an acoustic and thermal shield for a motor vehicle, the shield comprising:
a thermo-compressed porous three-dimensional shell based on glass fibers, the fibers being joined together by a binding agent of thermosetting type, like a phenolic resin,
a foam-based inner spring layer—in particular made of polyurethane—elastically compressible,

the shield additionally having the following features:
the layer is produced by reaction injection molding (RIM), the layer overmolding the shell,
the shell has a porosity arranged in order to enable the foam to penetrate a fraction of the thickness of the shell, so as to create a leaktight skin, such that the shield:
is acoustically insulating according to a mass-spring principle, the shield additionally having acoustic absorption properties conferred by the fraction of thickness of the shell not penetrated by the foam and remaining porous,
has the rigidity thereof increased by the reinforcement brought by the fibers coated by the foam.

Such an arrangement makes it possible to minimise the weight of the shields, in order to lighten the vehicles.

Indeed, it is possible to provide the use of a shell of lesser surface mass, without degrading the rigidity of the shield, this by the reinforcement brought by the glass fibers—well known for the use thereof as reinforcing fibers in the composite materials—coated by the foam in the fraction of thickness of the shell penetrated by the foam.

Moreover, the spring layer can be easily shaped, because it is obtained by molding, according to complex geometries—in particular non-developable—such as they can be found for certain components—such as an oil housing or a gearbox—to be protected by the shield.

Because of this, the visible face of the spring layer can be shaped so as to mold as closely as possible to the shape of a wall of the component to be protected, which makes it possible to ensure an optimisation of the acoustic and thermal insulation brought by the shield.

Finally, a sealing between the shell and the spring layer is ensured by the penetration of the foam in a fraction of the thickness of the shell.

In this manner, such a shield is able to ensure an acoustic protection by insulation according to a mass-spring principle, the fraction of thickness of the shell non-impregnated by the foam, making it possible moreover to achieve an acoustic absorption.

Furthermore, such a shield is able to ensure a thermal protection which can in particular be sought, when it is desired to confine the heat for a certain duration around the component to be protected, this in particular when a quick restart of the vehicle is desired after the engine thereof has been stopped.

However, the use of a binding agent of thermosetting type presents a serious disadvantage in that the shell has a low deformation capacity.

Because of this, it risks being broken during the mounting operation of the shield on a component to be protected by the shield.

Furthermore, the cutting operations on the shell are made difficult because of the breaking character thereof and the soiling of the cutting tools by the thermosetting binding agent.

Finally, a difficulty in controlling the fraction of thickness of shell penetrated by the foam is observed in such shields, the risk being to have a fraction which is too large, which would risk damaging the acoustic absorption properties of the shield linked to the porosity of the fraction of thickness non-penetrated by the foam.

### SUMMARY OF THE INVENTION

The invention aims to overcome these disadvantages.

To this end, and according to a first aspect, the invention proposes an acoustic and thermal shield for a motor vehicle, the shield comprising:
a thermo-compressed porous three-dimensional shell based on glass fibers, the fibers being joined together by a binding agent,
a foam-based inner spring layer—in particular made of polyurethane—elastically compressible,

the shield additionally having the following features:
the layer is produced by reaction injection molding (RIM), the layer overmolding the shell,
the shell has a porosity arranged in order to enable the foam to penetrate a fraction of the thickness of the shell, so as to create a leaktight skin, such that the shield:
is acoustically insulating according to a mass-spring principle, the shield additionally having acoustic absorption properties conferred by the fraction of thickness of the shell not penetrated by the foam and remaining porous,
has the rigidity thereof increased by the reinforcement brought by the fibers coated by the foam,
the binding agent is based on polypropylene,
the shell comprises between 45 and 55% by weight of glass fibers.

With the proposed arrangement, the shield has, by the thermoplastic nature of the binding agent, a good ability to deform without breaking the shell.

Because of this, the risk of breaking the shell during the mounting of the shield is removed.

Furthermore, the possible cutting operations on the shell are facilitated.

The applicant has also observed that the fact that the shell comprises between 45 and 55% by weight of glass fibers, makes it possible to achieve an optimal penetration of the foam within the shell, a sufficient fraction of thickness of the shell remaining exempt of foam, which enables the shield to have satisfactory acoustic absorption properties.

According to other aspects, the invention proposes a mounting of such a shield and a method for producing such a shield.

### BRIEF DESCRIPTION OF THE DRAWING

Other particularities and advantages of the invention will appear in the following description, made in reference to the attached FIGURE which is a schematic cross-sectional view of a mounting of a shield, according to an embodiment, on a component to be protected.

### DETAILED DESCRIPTION

In reference to the FIGURE, an acoustic and thermal shield 1 for a motor vehicle is described, the shield comprising:
a thermo-compressed porous three-dimensional shell 2 based on glass fibers, the fibers being joined together by a binding agent,
a foam-based inner spring layer 3—in particular made of polyurethane—elastically compressible,

the shield additionally having the following features:
the layer is produced by reaction injection molding (RIM), the layer overmolding the shell,
the shell has a porosity arranged in order to enable the foam to penetrate a fraction 4 of the thickness of the shell, so as to create a leaktight skin 5, such that the shield:
is acoustically insulating according to a mass-spring principle, the shield additionally having acoustic absorption properties conferred by the fraction of thickness of the shell not penetrated by the foam and remaining porous,
has the rigidity thereof increased by the reinforcement brought by the fibers coated by the foam,
the binding agent is based on polypropylene,
the shell 2 comprises between 45 and 55% by weight of glass fibers.

According to an embodiment, the skin 5 has a thickness of between 0.3 and 1 mm.

The shell 2 can itself typically have a thickness of between 2 and 3 mm.

In a non-represented manner, it can be provided that the shell 2 is provided, on at least one of the faces thereof, with a non-woven protective layer.

The presence of such a layer makes it possible to bring a protection to production operators faced with the risks of cuts by the glass fibers contained in the shell 2.

Such a protective layer in particular has a surface mass of between 15 and 120 g/m² and in particular a resistance to the passage of air of between 50 and 180N.s.m⁻³.

With such features, a protective layer arranged towards the spring layer 3 does not substantially interfere with the penetration of a fraction 4 of the thickness of the shell 2 by the foam, to form the skin 5.

According to a non-represented embodiment, the outer face—i.e. that opposite the spring layer 3—of the shell 2 is covered by a coating layer, for example based on fabric.

According to an embodiment, the binding agent is produced by polypropylene particles, so as to ensure a binding of fibers to one another according to a multiplicity of binding points, as will be explained later.

Now, a mounting of such a shield 1 is described, the mounting comprising the shield and a component 6 to be protected, the component—for example in the form of an oil housing or a gearbox—being delimited by a wall 7, in particular made of sheet metal, the visible face 8 of the spring layer 3 being shaped so as to mold substantially the shape of the wall, so as to make it possible for an optimisation of the acoustic and thermal insulation.

Finally, a method for producing such a shield 1 is described, the method comprising the successive following steps:
producing a mixture of glass fibers and polypropylene particles, the percentage by weight of the fibers with respect to the total weight of the fibers and particles being between 45 and 55%, the mixture being dispersed in a liquid matrix,
producing, with the mixture dispersed in the matrix, a continuously unwound fibrous ply,
making the ply pass into a furnace so as to evaporate the matrix and to achieve the fusion of the particles, in order to have a dry ply,
producing a calendaring of the dry ply so as to compress it and to connect the fibers to one another by the polypropylene once cooled forming a binding agent,
producing, from a blank of the compressed ply, by compression between two walls of a hot compression mold, a thermo-compressed porous three-dimensional shell 2 based on the glass fibers, the fibers being joined together by the polypropylene,
arranging the shell against a wall of a reaction injection mold (RIM), the visible face 9 of the shell being arranged towards the wall,
injecting on the shell, within the molding cavity defined by the mold, a precursory foam mixture—in particular made of polyurethane—elastically compressible,
after expansion of the foam, demolding the shield 1 obtained.

Such a method falls under an embodiment by “paper”, in reference to the dispersion of the fibre/particle mixture in a liquid matrix which is then removed.

The interest in such a process, compared with another manner of proceeding consisting of achieving a co-needling of glass fibers with polypropylene fibers configured to form a binding agent after the fusion thereof, is to make it possible for a binding of the fibers to one another according to a multiplicity of binding points.

This results in the formation of a dry ply, and subsequently a shell 2, having a higher rigidity than if it was obtained by the above-mentioned process involving a co-needling.

In this manner, the rigidification of the shield 1 brought by partial penetration of foam in the shell 2 is improved, knowing that the shield however retains a sufficient flexibility to be able to be mounted or provided with cuts without it resulting in a deterioration.

According to an embodiment, the shell 2 is obtained from a dry ply having a surface mass of between 500 and 800 g/m², knowing that, in the prior art, it is possible to start from a ply having a surface mass of around 1000 g/m² or more.

In a non-represented manner, it can be provided that the ply is calendared with at least one non-woven protective layer, such as described above, arranged on at least one of the faces thereof.

What is claimed is:

1. An acoustic and thermal shield for a motor vehicle, the shield comprising:
a thermo-compressed porous three-dimensional shell based on glass fibers, the fibers being joined together by a binding agent,
a foam-based inner spring layer made of elastically compressible polyurethane,
the shield further comprising:
spring layer produced by reaction injection molding, the layer overmolding the shell,
the shell having a porosity arranged to enable the foam to penetrate a fraction of the thickness of the shell, to create a leaktight skin, such that the shield:
is acoustically insulating according to a mass-spring principle, the shield additionally having acoustic absorption properties conferred by the fraction of thickness of the shell not penetrated by the foam and remaining porous,
has the rigidity thereof increased by the reinforcement by the fibers coated by the foam,
the shield having:
the binding agent based on polypropylene, and
the shell comprises between 45 and 55% by weight of glass fibers.

2. The shield according to claim 1, wherein the skin has a thickness of between 0.3 and 1 mm.

3. The shield according to claim 1, wherein the shell is provided, on at least one of the faces thereof, with a non-woven protective layer.

4. The shield according to claim 1, wherein the binding agent is produced by polypropylene particles, to ensure a binding of the fibers to one another by a multiplicity of binding points.

5. A mounting comprising a shield according to claim 1, comprising the shield and a component to be protected, the component being delimited by a wall, the visible face of the spring layer being shaped to substantially mold the shape of the wall, to make it possible for an optimisation of the acoustic and thermal insulation.

6. A method for producing a shield according to claim 4, wherein the method comprises the following steps:
producing a mixture of glass fibers and polypropylene particles, the percentage by weight of the fibers with respect to the total weight of the fibers and particles being between 45 and 55%, the mixture being dispersed in a liquid matrix,
producing, with the mixture dispersed in the matrix, a continuously unwound fibrous ply,
passing said ply into a furnace to evaporate the matrix and to achieve the fusion of the particles, to have a dry ply,
producing a calendaring of the dry ply to compress it and to connect the fibers to one another by the polypropylene once cooled forming a binding agent,
producing, from a blank of the compressed ply, by compression between two walls of a hot compression mold, a thermo-compressed porous three-dimensional shell based on the glass fibers, the fibers being joined together by the polypropylene,
arranging the shell against a wall of a reaction injection mold, the visible face of the shell being arranged towards the wall,
injecting on the shell, within the molding cavity defined by the mold, a precursory foam mixture made of elastically compressible polyurethane,
after expansion of the foam, demolding the shield obtained.

7. The method according to claim 6, wherein the shell is obtained from a dry ply having a surface mass of between 500 and 800 g/m².
